(19) United States
(12) Patent Application Publication
(10) Pub. No.: US 2007/0268204 A1
(43) Pub. Date: Nov. 22, 2007

(54) DRIVER CIRCUIT

(76) Inventor: Kazuyoshi Kawabe, Yokohama (JP)

Correspondence Address: Patent Legal Staff;Eastman Kodak Company, 343 State Street, Rochester, NY, 14650-2201, US

(21) Appl. No.: 11/744,295

(22) Filed: May 4, 2007

(30) Foreign Application Priority Data
May 19, 2006 (JP) 2006-140848

(51) Int. Cl. G09G 1/14

(52) U.S. Cl. 345/24

(57) ABSTRACT

A driver circuit for supplying a display video signal to a display panel, the driver circuit including a signal processing unit that processes an incoming input digital video signal; an output unit that outputs to the display panel the video signal processed by the signal processing unit, and the signal processing unit includes a programmable logic unit for setting a function according to configuration data stored in a memory.

### CROSS-REFERENCE TO RELATED APPLICATION

This application claims priority of Japanese Patent Application No. 2006-140848 filed May 19, 2006 which is incorporated herein by reference in its entirety.

### FIELD OF THE INVENTION

The present invention relates to a driver circuit for supplying a signal to a display device.

### BACKGROUND OF THE INVENTION

Most display devices, such as an LCD (liquid crystal display) and an organic EL display, receive a video signal as an analog signal from an external driver IC (integrated Circuit). On the other hand, as for the video signal to be displayed, a digital signal format is usually used for such reasons as prevention of deterioration caused by transmission, and easy processing. Therefore, most of the driver ICs supplying a video signal to a display device receive a digital signal as input and output an analog signal. Thus, in such driver ICs, there are both a digital signal processing unit and an analog signal processing unit. Typically, the analog signal outputted from a driver IC is about 5 V to 10 V, and the operating voltage of a digital processing unit is about 3.3 V, so the driver IC is fabricated by a process where different breakdown voltages are used.

The analog signal processing unit is constituted of a DAC (Digital Analog Converter) and a buffer amplifier which are basic components. In this case, with emphasis on accuracy and fluctuations of outputted analog signals rather than on functions, designing is optimized with respect to these factors. This is the reason why the analog signal processing unit often occupies a large area within an IC chip, thus limiting the freedom of design.

On the other hand, for the digital signal processing unit, the degree of integration can be increased. Thus, the digital signal processing unit occupies a smaller area in an IC chip than the analog signal processing unit does, so a variety of functions can be included therein and the freedom of design is larger.

As the driver IC of an LCD for a medium or small sized mobile terminal, with increasing requests for low power consumption, space-saving and the like, an advanced driver IC having a digital signal processing unit provided with a frame memory and image processing function is often used.

In the future, it is expected that high-performance terminals provided with various functions will be developed, such as terminals having a function of reproducing not only music but also moving pictures, the function being added to a mobile digital broadcast receiving terminal or mobile music player. Also, in order to improve the functions and performance while maintaining low power consumption and low cost, it would be effective to allow a driver IC to perform some of the video processing which has hitherto been performed by a main processor of the terminal, called an application processor or digital signal processor.

However, when the driver IC includes too many functions, it will take time from defining of specifications to tests after installation. Generally, it is often the case that whenever new products are introduced, new functions are requested. It is thus highly likely that development time will be prolonged. In the future, it is expected that marketing cycle of new products will become increasingly short and also the products will become diversified. Consequently, earlier product delivery and limited production of diversified products may be demanded.

### SUMMARY OF THE INVENTION

According to the present invention, there is provided a driver circuit for supplying a display video signal to a display panel, the driver circuit comprising a signal processing unit that processes an input digital video signal received, and an output unit that outputs the video signal processed by the signal processing unit to the display panel, wherein the signal processing unit includes a programmable logic unit for setting a function according to configuration data stored in a memory.

Preferably, the signal processing unit outputs the processed digital video signal, and the output unit includes a digital-analog converter that converts the processed digital video signal into an analog video signal and outputs the analog video signal thus obtained to the display panel.

Preferably, the signal processing unit outputs the processed digital video signal, and the output unit includes a level shifter that level-shifts the processed digital video signal and outputs the digital video signal thus shifted to the display panel.

Preferably, the memory storing the configuration data is a nonvolatile memory.

Preferably, the nonvolatile memory is arranged within the signal processing unit.

Preferably, the nonvolatile memory is arranged outside the signal processing unit.

According to the present invention, there is included the programmable logic unit capable of setting its function according to configuration data. Thus, it is possible to set the content of signal processing according to configuration data, facilitating limited production of diversified driver circuits having various types of functions. Further, it is also possible to modify the function of a manufactured driver circuit.

### BRIEF DESCRIPTION OF THE DRAWINGS

FIG. 1 is a configuration diagram of a driver circuit according to an embodiment of the present invention;

FIG. 2 is a view depicting an illustrative example of a circuit implemented by use of programmable logic;

FIG. 3 is a view illustrating an internal configuration of the decode circuit 5;

FIG. 4 is a configuration diagram of a driver circuit intended for a digitally driven display;

FIG. 5 is a view illustrating an exemplary configuration in which a level shifter and a buffer are arranged on the display panel side;

FIG. 6 is a view illustrating an exemplary configuration of the decode circuit;

FIG. 7A is a view illustrating a configuration in which a nonvolatile memory is arranged within the programmable logic unit; and

FIG. 7B is a view illustrating a configuration in which a nonvolatile memory is arranged outside the programmable logic unit.

### DESCRIPTION OF THE PREFERRED EMBODIMENTS

An embodiment of the present invention will be described below with reference to the drawings.

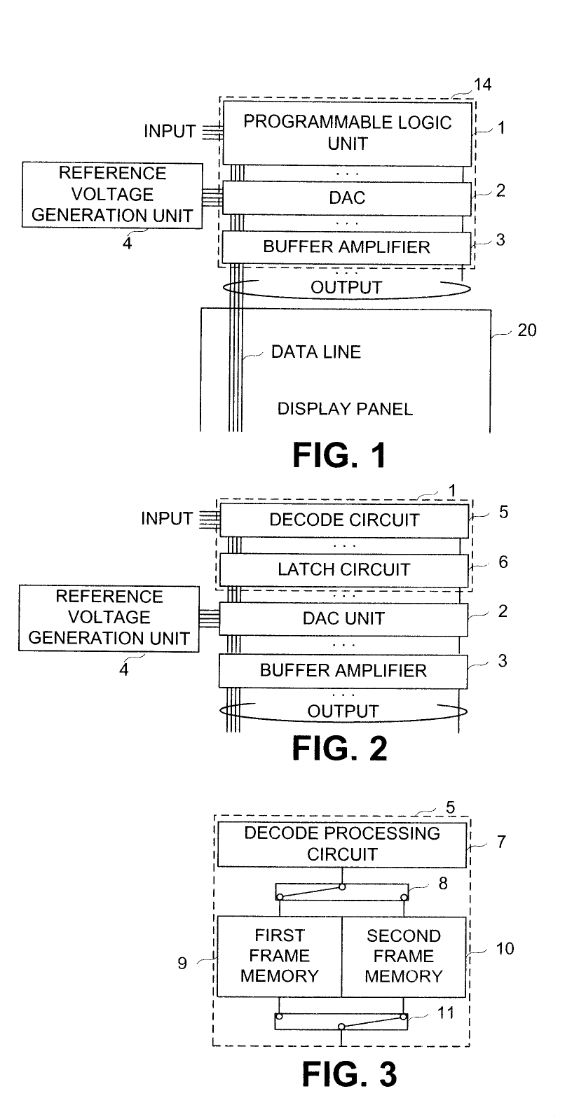

FIG. 1 is a configuration diagram of a driver circuit 14 according to an embodiment of the present invention. The driver circuit 14 is usually constructed as a driver IC, and an output thereof is connected to a data line of a display panel 20 when used. The driver IC constituting the driver circuit 14 is preferably connected via a flexible cable to the display panel 20, but may alternatively be connected directly to the display panel 20 by COG (Chip On Glass) or the like.

The driver circuit 14 of FIG. 1 has a programmable logic unit 1 constituting a signal processing unit and receives digital display data from the outside via the programmable logic unit 1. Several circuits for processing input data are implemented in the programmable logic unit 1, and processed data is outputted to a DAC 2. The DAC 2 selects a voltage corresponding to the data from among a plurality of stepwise changed voltages supplied from a reference voltage generation unit 4 and outputs it to a buffer amplifier 3. The buffer amplifier 3 performs impedance conversion and outputs with a larger driving force an analog voltage corresponding to the data to the data line of the display panel 20. In this instance, the DAC 2 and the buffer amplifier 3 constitute the output unit.

The programmable logic unit 1 includes circuit resources such as a RAM (Random Access Memory) and a PLL (Phase Locked Loop) in addition to the programmable logic unit. The size of the RAM and the operating frequency of the PLL can be set freely.

The operation of these circuit resources and programmable logic unit is determined by receiving data which define the operation of the circuits. Such data are called configuration data, and are retained in a nonvolatile memory arranged within the programmable logic unit 1 or outside the programmable logic unit 1. When the content of this configuration data is modified and downloaded into the nonvolatile memory, a different operation of the circuit resource or programmable logic unit 1 can be implemented.

More specifically, the programmable logic unit 1 includes, for example, a gate array or the like having a CMOS as the constituent element, and the connection and the like between each component thereof can be set according to configuration data, so its logic etc. can be set in a programmable manner. As the nonvolatile memory 1a, a flash memory, EEPROM or the like is preferably used.

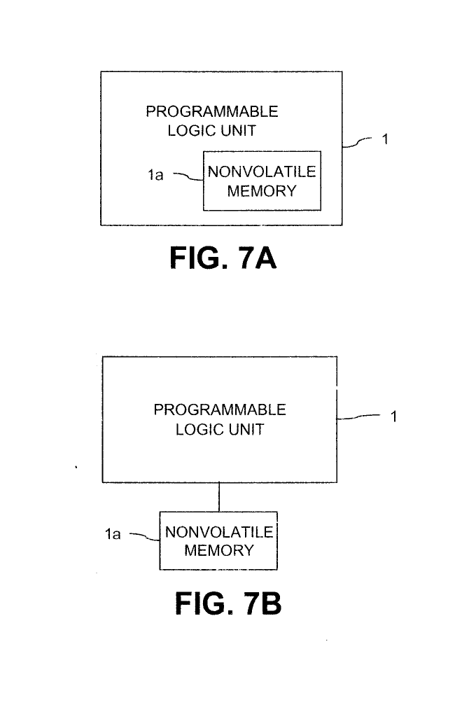

FIG. 7A illustrates an example where the nonvolatile memory 1a storing configuration data is arranged within the programmable logic unit 1, and FIG. 7B illustrates an example where the nonvolatile memory 1a storing configuration data is arranged outside the programmable logic unit 1.

In FIG. 1, there is schematically illustrated a typical driver circuit 14 having a configuration intended for an active matrix display of liquid crystal, organic EL or the like. However, the use of programmable logic being one feature of the present invention is also applicable to a passive matrix display of liquid crystal, organic EL or the like. It is noted that, for an organic EL display, there are some cases where the driver circuit 14 outputs current to the data line.

In FIG. 2, there is illustrated an illustrative example of a circuit implemented by the use of programmable logic. Generally, data of three primary colors (red, green and blue) with respect to each pixel are received from the outside along with control signals. However, in the case of FIG. 2, the video data used is in a compression format such as JPEG or MPEG, that are currently often used, or an encoded format such as encrypted. This video data can be called communication data, and the programmable logic unit 1 can receive data of any format.

For example, when sending video data also, file data in JPEG format can be sent by TCP/IP (Transmission Control Protocol/Internet Protocol) being a network communication protocol, or by USB (Universal Serial Bus) being an interface often used by personal computers.

When input data is compressed video data, the amount of transferred data can be reduced, so an advantage can be expected that power consumption for data transfer will be reduced, and when input data is encrypted data, it is possible to implement secure communication in which unauthorized viewing of data transferred to the driver circuit is not possible.

As the transfer method, for example, reception of 8-bit parallel data of CMOS level is possible, or serial transmission using a differential signal having low EMI (Electro Magnetic Interference) and allowing high speed transmission may be used.

A decode circuit 5 implemented by programmable logic restores compressed or encrypted video data to the original video data and transfers the restored data to a latch circuit 6. The digital data of the latch circuit 6 is outputted as an analog signal via the DAC 2 and buffer amplifier 3.

FIG. 3 illustrates an internal configuration of the decode circuit 5. Input encoded data is decoded by a decode processing circuit 7. The decoded data is stored frame by frame via a video input switch 8 alternately into one of the first and second frame memories. FIG. 3 illustrates a process for storing data into the first frame memory 9. During this process, the output of the second frame memory in which decoded data of the preceding frame processed by the decode processing circuit 7 is stored, is connected via a video output switch 11 to the output of the decode circuit 5 to output the decoded data to the latch circuit 6.

When the transfer of decoded data to the first frame memory 9 is completed, a switchover of the video input switch 8 is made to send decoded data to the second frame memory. At this time, the output of the first frame memory 9 is connected via the video output switch 11 to the output of the decode circuit 5 to output the video data stored in the first frame memory 9. A switchover is made alternately in the video input switch 8 and the video output switch 11, whereby the decoded video data is outputted as continuous video data without being interrupted.

It is noted that all the above functions do not always have to be implemented by programmable logic. For example, only part of the decode processing circuit 7 may be implemented by programmable logic.

Here, an advantage of implementing these functions by use of programmable logic is as follows. In ordinary development of a driver IC, functions are installed after a considerable time has passed since defining of specifications, so tests after installation cannot be performed before that time. When programmable logic is used, installation of functions is possible at the step of defining specifications. Accordingly, tests can be started early and problems can be solved quickly. Also, circuit scale and power consumption can be estimated at an earlier stage, so cost measures and reduction of power consumption can also be addressed at an earlier stage. When it is determined by the tests that the performance is satisfactory, a mask is newly produced to fabricate a driver IC. As a result, any problems associated with function enhancement can be minimized.

Further, in the case of limited production of diversified products also, the use of programmable logic is effective. Using programmable logic, a variety of circuits can be constructed, so it is possible for an identical driver IC to constitute a driver IC having a different function. For example, assume that one driver IC must perform JPEG decoding, while another driver IC must perform MPEG decoding. In this instance, when architecture using programmable logic is used, the same driver IC can implement a different function. According to prior art, two different driver ICs must be fabricated, thus doubling development cost, and in the case of limited production, the unit cost will further increase.

Further, the following services can also be provided. For example, as the decode circuit 5, there can be implemented a driver IC which is provided originally at low cost, having specifications supporting only JPEG decoding, and which is changed to an MPEG decode function online using a network such as the Internet, or to which the above function is added, or which is upgraded to have another function. By virtue of the characteristics of programmable logic, similarly to software installation, means for implementing functions can be provided.

However, the scale of implementable circuitry using programmable logic is limited to some extent, so installation of too many functions is disadvantageous from a viewpoint of cost. Thus, if configuration data is transferred to the driver IC 14 along with video data and the configuration data is reflected in the programmable logic immediately before displaying the video data to thereby constitute the logic, then only required logic is installed in an on-demand basis, allowing minimization of the scale of programmable logic circuit.

For example, when video data to be sent is of the JPEG format, configuration data for JPEG decoding is also sent along with the video data, and the configuration data is reflected before the JPEG video data is displayed, to cause the decode circuit 5 to implement a JPEG decode function. When JPEG data is continuously sent, configuration data does not need to be sent, or is not reflected even when it is sent, and the programmable logic continues to provide the JPEG decode function. In this instance, when configuration data is sent to the driver circuit 14, an identification code is preliminarily affixed to the data. The driver circuit 14 identifies the identification code and recognizes that the sent data is configuration data, and stores the configuration data in the nonvolatile memory 1a.

Accordingly, even when video data is produced using various formats, if configuration data for decoding the video data is transferred simultaneously, the video data can be decoded by small-scale programmable logic.

For example, when video captured with a digital camera or the like is displayed, if JPEG and MPEG decode functions are preliminarily configured, displaying is performed satisfactorily. That is, in this case, advanced processing functions such as 3D graphics processing often used in games or the like, need not be included simultaneously. As illustrated in FIG. 6, when the decode circuit 5 is constituted of a JPEG decoder, MPEG decoder and 3D graphics processing circuit, and when the size of decode circuit implementable by programmable logic is limited, then it is preferable to implement a required function with a minimum circuit rather than to arrange all the functions in the circuit. If control is performed so that JPEG and MPEG decoders are mounted when displaying captured video, and when displaying video such as game, the above decoders are replaced by a 3D graphics processing circuit, then it is possible to effectively use the limited programmable logic area. This also applies to other functions in the same way.

In order to output an analog signal, the above described driver IC 14 has the analog signal processing unit. This analog signal processing unit occupies a large circuit area, making the unit unsuitable for increasing the scale of programmable logic in the driver IC. When the scale of programmable logic is increased, a digitally driven display panel is appropriate in which only a digital signal is outputted by the driver IC. Details of digital drive have been described, for example, in WO 2005/116971.

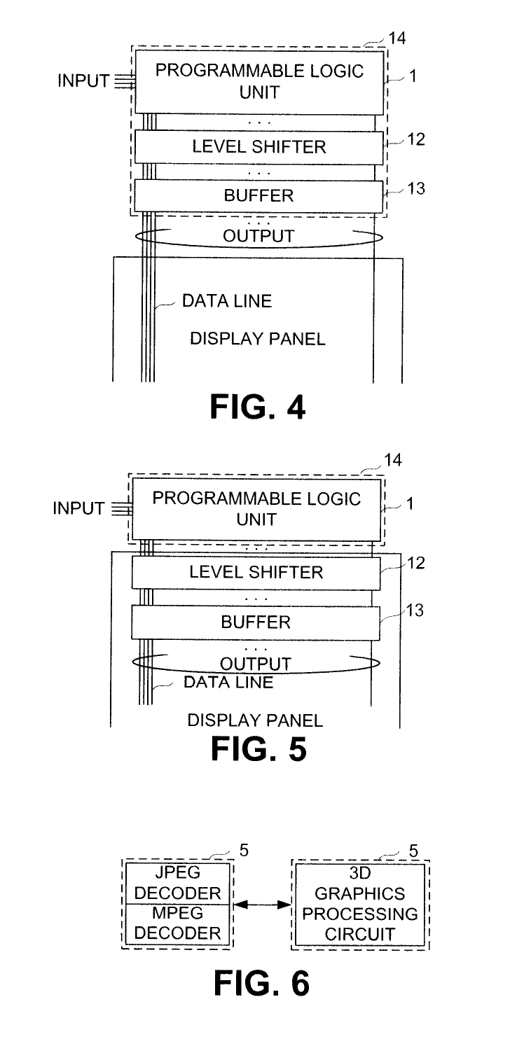

FIG. 4 illustrates a configuration diagram of a driver circuit intended for a digitally driven display. A programmable logic unit 1 receives input data, performs the above described functions, and outputs the resultant data to a level shifter 12. The level shifter 12 converts a signal level used in the programmable logic unit 1 into an output signal level as required, and outputs it to a buffer 13. The buffer 13 outputs the digital signal level-shifted with a large driving force and drives a data line of a display panel at high speed. Compared to FIG. 1, the analog signal processing unit is not needed so the circuit area can be significantly reduced. When the area obtained by the reduction is assigned as the programmable logic area or memory area, further improvement of function can be achieved.

The level shifter 12 and the buffer 13 may be formed within the display panel as illustrated in FIG. 5. When a low-temperature poly-silicon TFT is used, a level shifter 12 and a buffer 13 which operate at high speed can be formed. When arranged in this manner, the whole driver circuit can be constituted of the programmable logic unit 1, thus increasing the degree of freedom in circuit configuration. Also, by virtue of miniaturization of the semiconductor process, programmable logic having a large degree of integration and capable of operating at a high speed can be produced currently, so it is possible to construct an advanced driver IC which operates at high speed.

The above description is about typical functions which can be implemented within the driver IC by use of programmable logic. Characteristic advantages obtained when digital drive is used will now be described.

Digital drive is characterized in that the range of gradation reproduction is determined by the number of subframes. For example, at least 6 subframes are needed for displaying 6-bit gradation, and at least 8 subframes are needed for displaying 8-bit gradation. That is, it is possible to display a wide gradation range by use of a single driver IC within the allowable range of panel driving frequency.

On the other hand, in the analog-output-type driver IC as illustrated in FIG. 2, the range of gradation reproduction is preliminarily determined. Accordingly, for example, reproduction of 64 or more levels is fundamentally not possible with a 6-bit gradation driver IC, and reproduction of 256 or more levels is not possible with an 8-bit gradation driver IC. Consequently, a driver IC to be used is basically determined based on cost, and video is displayed within the determined gradation range.

In the case of digital drive, it is possible to implement 6-bit, 8-bit and further 10-bit gradation by use of a signal driver IC. First of all, this can be called a programmable drive method. When the part for generating subframes is constituted of programmable logic, the logic can be constructed so that subframes up to the limits of frequency dependent on an ability of the panel can be received.

As the number of subframes increases, power consumption becomes larger, so a smaller number of subframes are desirably used for mobile information terminals. However, in TV or the like, because of the demand for high video quality, it is considered that a larger number of subframes are desirably used to implement a wide gradation range.

When programmable logic is used in a digitally driven driver IC, these functions can be configured in a programmable manner and thus many requests can be handled with a single driver IC.

The invention has been described in detail with particular reference to certain preferred embodiments thereof, but it will be understood that variations and modifications can be effected within the spirit and scope of the invention.

### PARTS LIST

1 logic unit
1a nonvolatile memory
2 DAC (Digital Analog Converter)
3 amplifier
4 voltage generation unit
5 decode circuit
6 latch circuit
7 processing circuit
8 input switch
9 memory
12 level shifter
13 buffer
14 driver
20 display panel

1. A driver circuit for supplying a display video signal to a display panel, the driver circuit comprising:
a signal processing unit that processes an incoming input digital video signal;
an output unit that outputs to the display panel the video signal processed by the signal processing unit, and
the signal processing unit includes a programmable logic unit for setting a function according to configuration data stored in a memory.

2. The driver circuit according to claim 1, wherein:
the signal processing unit outputs the processed digital video signal; and
the output unit includes a digital-analog converter that converts the processed digital video signal into an analog video signal and outputs the analog video signal thus obtained to the display panel.

3. The driver circuit according to claim 1, wherein:
the signal processing unit outputs the processed digital video signal; and
the output unit includes a level shifter that level-shifts the processed digital video signal and outputs the digital video signal thus level-shifted to the display panel.

4. The driver circuit according to claim 1, wherein the memory storing the configuration data is a nonvolatile memory.

5. The driver circuit according to claim 4, wherein the nonvolatile memory is arranged within the signal processing unit.

6. The driver circuit according to claim 4, wherein the nonvolatile memory is arranged outside the signal processing unit.
